(19) United States
(12) Patent Application Publication
(10) Pub. No.: US 2002/0052868 A1
(43) Pub. Date: May 2, 2002

(54) SIMD system and method

(76) Inventors: Sanjeev Mohindra, Andover, MA (US); John Kowalonek, Westborough, MA (US); Michael Kleeman, Sudbury, MA (US); Georges Melhem, Salem, NH (US)

Correspondence Address: FOLEY, HOAG & ELIOT, LLP, PATENT GROUP, ONE POST OFFICE SQUARE, BOSTON, MA, 02109, US

(21) Appl. No.: 09/971,203

(22) Filed: Oct. 4, 2001

Related U.S. Application Data
(60) Provisional application No. 60/237,975, filed on Oct. 4, 2000.

(51) Int. Cl. G06F 7/00

(52) U.S. Cl. 707/1

(57) ABSTRACT

Methods and systems to interface a SIMD array to a host computer operating system using one or more context sensitive filter controllers. The filter controllers or drivers can intercept I/O requests from the host operating system and redirect the requests to the SIMD array. By using the filter controllers, the SIMD array can be viewed by the host operating system as a file, database engine, and/or other storage device including a hard drive. Based on the request from the host, including the data content, document type, document content, and document or data format associated with the request, the filter controllers can provide a set of instructions to process the request using the SIMD array, while exploiting the parallel processing power of the SIMD array.

### CLAIM OF PRIORITY

This application claims priority to U.S. Ser. No. 60/237,975, entitled “SIMD Architecture For Accelerated Data Storage, Retrieval, And Processing”, filed on Oct. 4, 2000, and naming Sanjeev Mohindra, John Kowalanek, Michael Kleeman, and Georges Melhem as inventors, the contents of which are herein incorporated by reference in their entirety.

### BACKGROUND

(1) Field

The disclosed methods and systems relate generally to Single Instruction Stream, Multiple Data Stream (SIMD) arrays, and more particularly to a system and method for SIMD array processing.

(2) Description of Relevant Art

As the total internet content increases, the number of online transactions and electronic records increase accordingly. As more electronic data and information are generated, a scalable system is needed to store, retrieve and process the data. Many high-end commercial computing industry leaders are marketing loosely coupled multi-tier architectures where front-end processing engines are connected to the internet and formulate transactions, acting as coordinators across multiple database machines, to ensure data integrity. High-performance Symmetric Multi-Processor (SMP) database machines often sit behind these “front-end” machines, and process as many transactions as possible against a single database. The SMP architecture can introduce significant software complexity and can require database programmers and application designers to program systematically with respect to the system architecture, network connections, data integrity management, and failure points. Software tools can be used to address these problems, but the complexity and cost of these high-end systems can be high. Additionally, the system complexity often correlates to decreased reliability.

In addition to complex architectural schemes, traditional data storage mechanisms include mechanical storage devices like hard disk drives. The moving parts within a hard disk drive limit the speeds at which data can be retrieved from the disk. To retrieve or store the data, the read/write head must physically move to the right location on the disk before transferring data. This process results in large latencies and slow data transfer rates. The system throughput can be further limited because the data is retrieved through a single drive controller.

### SUMMARY

The disclosed methods and systems include a method for interfacing an operating system of a host computer and a Single Instruction Stream, Multiple Data Stream (SIMD) array. The methods include providing a context-sensitive filter controller for receiving a request from the host operating system and providing at least one instruction to process the request using the SIMD array. The filter controller can be context sensitive based on at least one of a data type, the request, a document type, the contents of a document, and document format.

The filter controller can receive a request from the host file manager and/or the host file system. Accordingly, the methods and systems can intercept requests from the host that can include an input/output (I/O) request, a read request, or a write request. The request can be serviced by the filter controller that provides instructions for processing the request using the SIMD array.

The filter controller, based on the context of the request, can arrange the data associated with the request, into modules, segments, partitions, etc., to exploit the parallel processing capabilities of the SIMD array. Accordingly, the filter controller instructions can be based on the context of the request, and the instructions can be used to form a library of instructions upon which future filter controllers can derive and/or provide instructions. The instruction set for a request can be referred to as a transaction, and transactions can also be incorporated into a library. Instructions can perform actions including searching, compression, uncompression, encoding, and decoding.

The SIMD array can be viewed as having three spaces that can be referred to as uncompressed space, transformation space, and compressed space. A filter controller can utilize the various spaces to respond to a request. For example, transformation space can be used as a scratchpad area. A memory allocator can coordinate the memory management of the SIMD array to provide the filter controller with appropriate addressing information for the multiple data and/or memory spaces in the SIMD array.

In one embodiment, the interface between the host and array can include a PCI bus, and instructions from the host to the processing elements of the SIMD array, and vice-versa, can be transferred via DMA.

Other objects and advantages will become apparent hereinafter in view of the specification and drawings.

### BRIEF DESCRIPTION OF THE DRAWINGS

FIG. 1 is a diagram of one architecture based on the methods and systems described herein;

FIG. 2 represents a portion of a SIMD array that can be used in a system according to FIG. 1;

FIG. 3 presents a SIMD array architecture;

FIG. 4 illustrates one architecture for complementing an existing processor-system architecture with a SIMD array;

FIG. 5 is a block diagram depicting an interface between a computer architecture and a SIMD array; and,

FIG. 6 illustrates one application for storing records in a SIMD array.

### DESCRIPTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore features, components, modules, and/or aspects of the illustrations can be otherwise combined, separated, interchanged, and/or rearranged without departing from the disclosed systems or methods.

Parallelism can be a key to improving data storage, retrieval, and processing system performance. The methods and systems disclosed herein address the problem of fast data storage, retrieval, and processing using massively parallel Single Instruction Stream, Multiple Data Stream (SIMD) systems. SIMD system architectures can offer several advantages over traditional computer architectures, including a large number of processors. In the methods and systems disclosed herein, the multiple SIMD processors can manipulate, process, and analyze data. Another SIMD advantage is the presence of a large amount of high-speed Random Access Memory (RAM) when compared to traditional computer architectures. The methods and systems disclosed herein present an architecture that can exploit the presence of a large amount of high-speed RAM to provide very fast data storage and retrieval capabilities.

In one embodiment, the methods and systems can be integrated into a file system of an operating system such as Windows 98, Windows 2000, Windows NT, Linux, UNIX, SunOS, or another operating system, such that the methods and systems can be viewed by the file and/or operating system as a file, database engine, and/or other storage device including a hard drive. This integration can be accomplished by intermediate filter drivers, referred to herein as filter controllers, that can intercept I/O requests from the native file system, and redirect the requests based on the methods and systems provided herein.

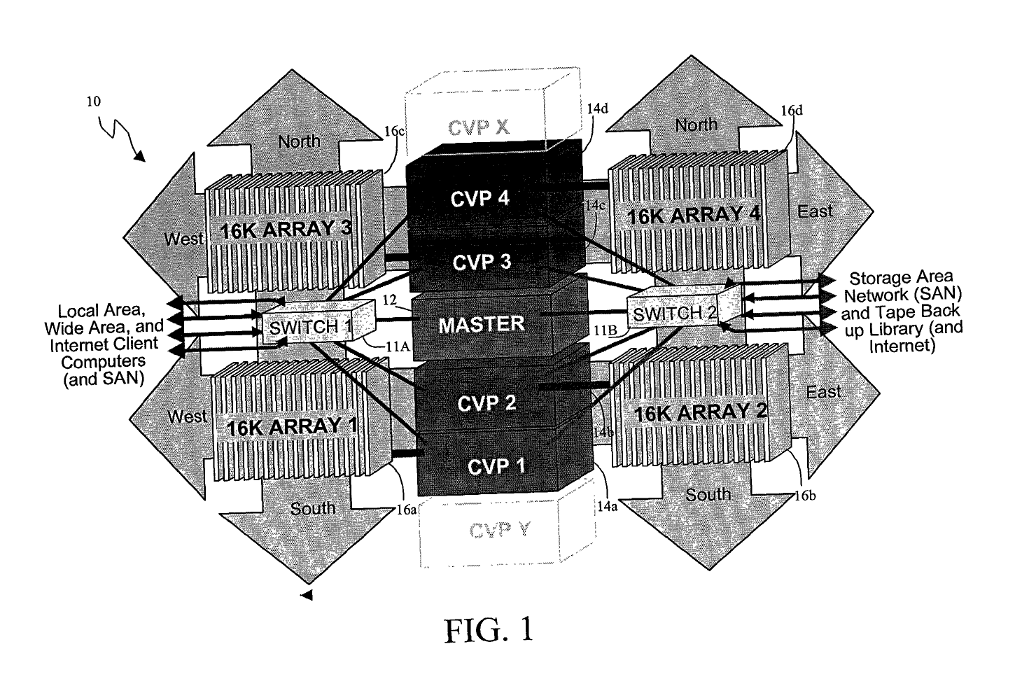

Referring now to FIG. 1, there is an illustrative architecture 10 that practices the principles of the disclosed methods and systems. The FIG. 1 system 10 includes a cluster of SIMD computers that can be used simultaneously or individually as, for example, a low latency computational server or a high speed data server. In one embodiment, the FIG. 1 system 10 can be dedicated to a single user or shared amongst several users. Additionally and optionally, the FIG. 1 system 10 can be connected, for example, using one or more switches 11a , 11b , to a single computer or can be configured as a shared device on a communications network such as the internet, an intranet, or another communications network, where such examples are intended for illustration and not limitation.

Referring to FIG. 1, there is a user machine labeled the Master 12 that can be in communications with the one or more Control and Virtual Processors (CVPs) 14a-14d that can further be in communications with at least one SIMD array 16a-16d. The Master 12 and CVPs 14a-14d can be understood herein to be processor or microprocessor-based systems including a computer workstation, such as a PC workstation or a SUN workstation, handheld, palmtop, laptop, personal digital assistant (PDA), cellular phone, etc., that includes a program for organizing and controlling the processor to operate as described herein. Additionally and optionally, the processor systems 12, 14a-14d can be equipped with a sound and video card for processing multimedia data. The systems 12, 14a-14d can operate as a stand-alone system or as part of a networked computer system. Alternatively, the systems 12, 14a-14d can be dedicated devices, such as embedded systems, that can be incorporated into existing hardware devices, such as telephone systems, PBX systems, sound cards, etc. In some embodiments as shown in FIG. 1, the systems 12, 14a-14d can be clustered together. The systems 12, 14a-14d can also include one or more mass storage devices such as a disk farm or a redundant array of independent disk (“RAID”) system for additional storage and data integrity. Read-only devices, such as compact disk drives and digital versatile disk drives, can also be connected to the systems 12, 14a-14d.

Accordingly, in the illustrated embodiment of FIG. 1, the Master 12 can distribute and schedule commands to the various SIMD arrays 16a-16d via the CVPs 14a-14d. In one embodiment of the FIG. 1 system, a CVP 14a-14d can act as its own master. Accordingly, in one embodiment, the Master 12 and/or the CVPs 14a-14d can interface to a network, receive data from the network via the illustrated switches 11a, 11b, process the data using one or more of the SIMD arrays 16a-16d, and return the data to the network or another device via the switches 11a, 11b. In another embodiment, data can be received from the network, processed by the system 10, and stored locally. Other uses and embodiments of the disclosed methods and systems will become readily apparent to those of ordinary skill in the art.

In the illustrated system 10, the CVPs 14a-14d can be connected to the Master 12 and the SIMD arrays 16a-16d using a Peripheral Component Interface (PCI) Bus, however the disclosed methods and systems can use other connectivity devices and protocols. As indicated herein, the illustrated CVPs 14a-14d can receive commands or requests for processing from the Master 12 or other user or host device, and distribute and collect data to and from, respectively, the SIMD arrays 16a-16d at the beginning and end of computations by the SIMD arrays 16a-16d. The CVPs 14a-14d can additionally forward data to other CVPs 14a-14d or external devices such as disk drives or other processors using high-speed network connections.

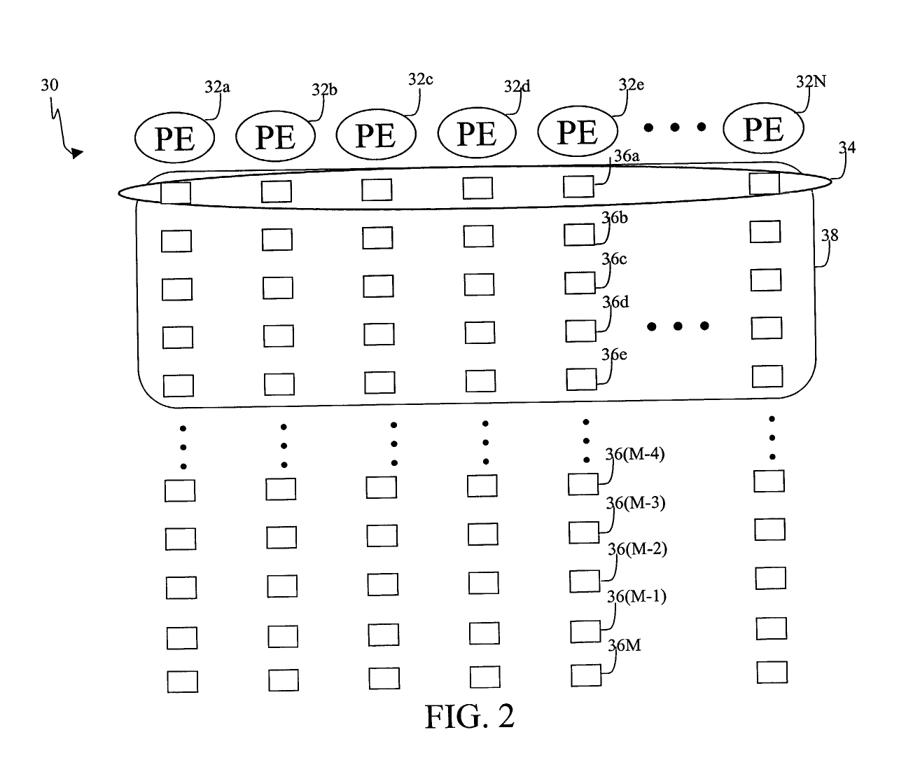

Referring now to FIG. 2, there is an illustration of a portion 30 of a SIMD array 16a-16d that can be used in a system such as the illustrated system of FIG. 1. As FIG. 2 illustrates, the SIMD array can include Processing Elements (PEs) 32a-32N that can be represented as a row of N PEs, where N can be a positive integer number greater than or equal to one. For the illustrated embodiments of FIGS. 1 and 2, data and instructions can be communicated between the CVPs 14a-14d and the PEs 32a-32N using a PCI bus.

The PEs 32a-32N can be a well-known PE for use in SIMD architectures that can be utilized as described herein. The illustrated PEs 32a-32N can thus include a processor such as, for example, an Arithmetic Logic Unit (ALU) and can include local memory for the processor that can include Random Access Memory (RAM).

As FIG. 2 indicates, at least one memory element 36a-36M, referred to herein as a data element, can be associated with a PE 32a-32N, where M can be a positive integer greater than or equal to one. The data element 36a-36M size can vary depending upon the application. For example, in some embodiments, the data elements 36a-36M can be on the order of one, two, eight, sixteen, thirty-two, and/or sixty-four bits, with such examples provided for illustration and not limitation. Data element sizes within an array 16a-16d can vary.

FIG. 2 presents the PEs 32a-32N and data elements 36a-36M in a matrix format for illustrative purposes. As indicated herein, a PE 32a-32N can be associated with one or preferably more data elements 36a-36M, where in the FIG. 2 illustration, a PE 32a-32N can be associated with the data elements 36a-36M in the same column as the PE 32a-32N. Those with ordinary skill in the art will recognize that the PEs 32a-32N within a SIMD array 16a-16d generally execute the same instruction simultaneously, and thus the PEs 32a-32N can be viewed as simultaneously processing an entire row 34 of data elements 36a-36M, where selected PEs 32a-32N can process a data element 36a-36M within the selected PEs' 32a-32N respective columns, thereby allowing the parallel processing provided herein. Those with ordinary skill in the art will recognize that SIMD systems can allow certain PEs 32a-32N to be enabled or disabled during an instruction.

In the FIG. 2 system that illustrates “16K SIMD arrays”, there can be 16 K (16,384) processing elements that can be associated with, for example, 256 G (2.62144e8) bytes of data elements 36a-36M, to provide 16,000 bytes per PE 32a-32N. For an embodiment where a data element is a byte, the illustrated array can include 16,000 rows. Those with ordinary skill in the art will recognize that there is not a limitation to the number of rows (i.e., data elements 36a-36M associated with a given PE 32a-32N) in the SIMD architecture. Similarly, there is not a limitation on the number of PEs 32a-32N in a SIMD array 16a-16d, or the size of a data element 36a-36M.)

With reference to FIG. 2, a “stripe” can be understood herein to be a row 34 of data elements 36a-36M, with the number of data elements in a stripe 34 being equal to the number of PEs 32a-32N in the SIMD array 16a-16d. Furthermore, a “filter block” 38 can be understood herein to be an integer number of stripes.

Referring back to FIG. 1, as provided herein previously, the Master 12 and/or CVPs 14a-14d can communicate data and instructions to the SIMD array 16a-16d PEs 32a-32N via a PCI bus, in one embodiment. The PEs 32a-32N can process the instructions and return data to the CVPs 14a-14d and hence the Master 12. Accordingly, in an architecture according to FIG. 1, SIMD arrays 16a-16d can be connected to provide thousands of PEs 32a-32N by connecting the SIMD arrays 16a-16d in a two-dimensional rectangular grid. FIG. 1 depicts the two-dimensional grid with arrows labeled North, South, East, or West, where the four SIMD arrays 16a-16d can connect to and communicate with up to three other SIMD arrays (not illustrated), where the up to three other (not illustrated arrays can also be connected to and communicate with three additional arrays (also not illustrated)). This continuum of SIMD array connections can continue as desired. Accordingly, because the SIMD PE array 16a-16d is scalable, an appropriate device capacity can be selected with consideration for the application, performance, and monetary concerns.

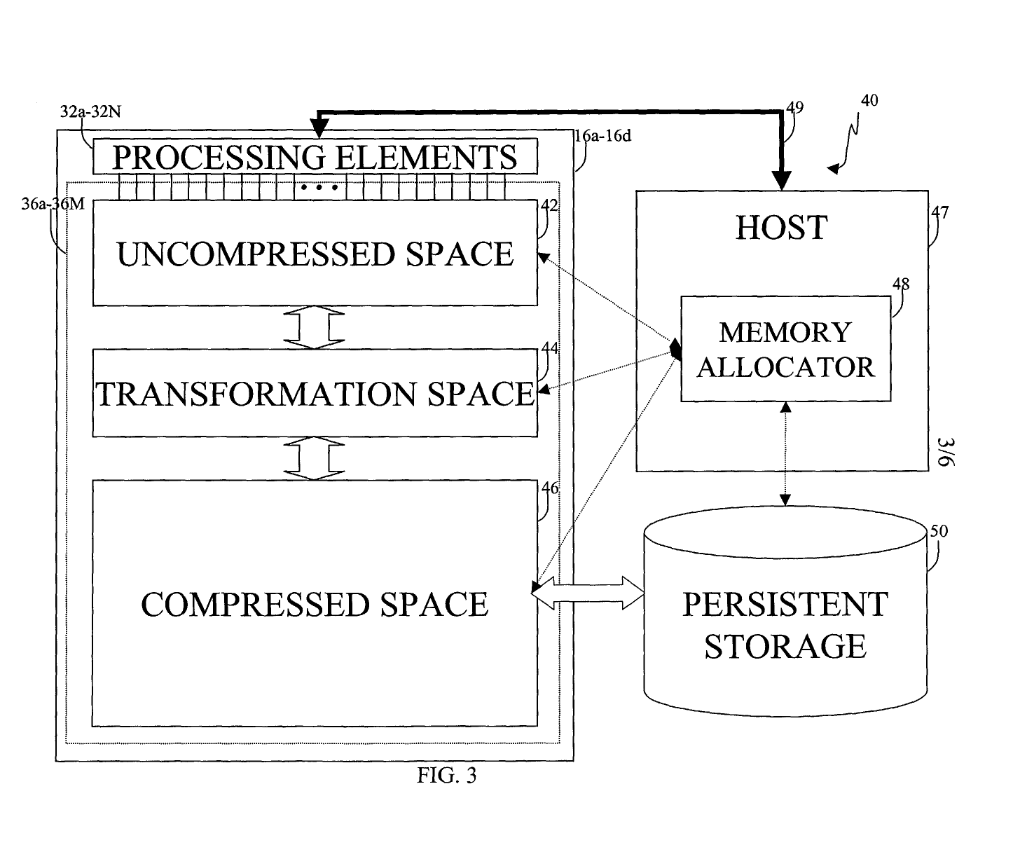

Referring now to FIG. 3, there is one embodiment 40 for dividing, partitioning, or otherwise segmenting the SIMD data elements 36a-36M into three memory areas that can be referred to as uncompressed space 42, transformation space 44, and compressed space 46. In the illustrated embodiment, the partitions 42, 44, 46 can be effectuated logically, however those with ordinary skill will recognize that the partitions 42, 44, 46 can be physical or a combination of physical and logical. In the illustrated embodiment, the partitions 42, 44, 46 are fixed in size and addressed as rows, however other embodiments practicing the systems and methods disclosed herein can include varying partition sizes and alternate partition addressing schemes. For example, in the FIG. 3 system, a row of uncompressed space 42, transformation space 44, and compressed space 46 includes N bits, where N is a positive integer number of PEs 32 in the SIMD array. Furthermore, in the illustrated FIG. 3 system, the rows in the partitions 42, 44, 46 can be understood to be one bit deep, although as provided herein, the methods and systems are not limited to such an embodiment.

The FIG. 3 uncompressed space 42, transformation space 44, compressed space 46, and a persistent storage device(s) 50, can be allocated and otherwise controlled by a memory allocator 48. The memory allocator 48 can allocate the memory partitions 42, 44, 46, 50 based on processing requests. As indicated in FIG. 3, the memory allocator 48 can be a software program that can reside on a host device 47 that can be the Master 12 or a CVP 14a-14d as previously provided herein. As also indicated, the host 47 and hence the memory allocator 48 can communicate with the PEs 32a-32N via a PCI bus 49. In one embodiment, the memory allocator 48 can track the space allocation in the three partitions 42, 44, 46 and the persistent store 50 using a bitmap. Accordingly, the memory allocator 48 can be informed of processing requests from the host 47, and in response, provide instructions or other addressing data pertaining to any one or more of the uncompressed space 42, transformation space 44, compressed space 46, and/or persistent storage 50, to allow the host 47 to create processing instructions based on the available memory in the various partitions 42, 44, 46, 50.

Referring again to FIG. 3, uncompressed space 42 can be viewed as one or more filter blocks 38 (FIG. 2), and in one embodiment, the uncompressed space 42 can be understood to be a cache of filter blocks 38. In the illustrated embodiments, data in the uncompressed space 42 filter blocks 38 can be immediately transferred to the transformation space 44, however in some embodiments, there can be a delay before the transfer. Data in the transformation space 44 can be compressed and thereafter transferred to the compressed space 46 as a compressed filter block 38. For the illustrated systems and methods, the transformation space 42 can therefore be viewed as a staging area or computational scratch pad, and those of ordinary skill in the art will recognize that the disclosed methods and systems can utilize a well-known compression method.

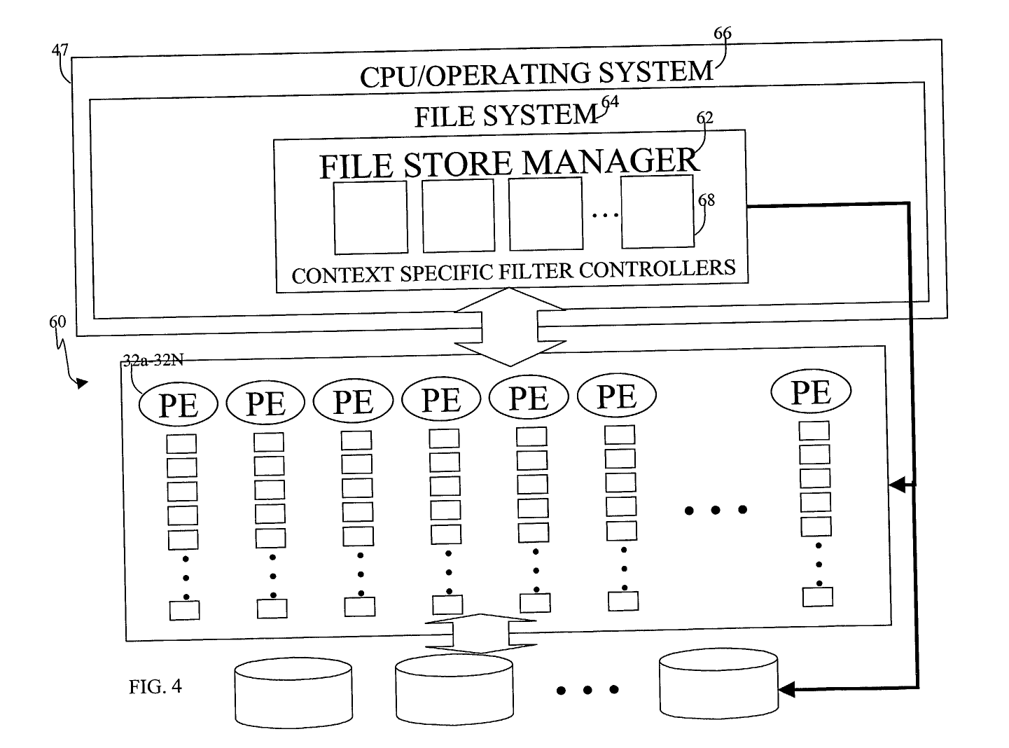

For the illustrated system, data stored in the compressed space 46 can be immediately written to the persistent storage area 50, although in some embodiments, there can be a delay before the transfer. As FIG. 3 also indicates, the memory allocator 48 can be in communications with the persistent storage 50 and can allocate segments or partitions of persistent storage 50 based on the contents of compressed memory 46. For the illustrated system, a data transfer between compressed space 46 and persistent storage 50 can be in the form of a lazy write or in-line write, depending on the application. The persistent storage 50 in the illustrated system can provide a map of compressed filter blocks, and persistent memory 50 can thus be a device such as a floppy disk, hard disk, compact disk, DVD, or combination thereof, with such examples provided for illustration and not limitation. When the systems disclosed and illustrated herein are in shut-down mode, the system 10 information and/or data from the memory partitions 42, 44, 46 can be stored in persistent storage or memory 50. Persistent memory 50 can therefore provide a backup mechanism in the case of system or data failure. Although in the illustrated embodiment, the sizes of uncompressed 42, transformation 44, and compressed 46 spaces do not vary, the size of persistent storage 50 can be varied. Additionally, in the illustrated system, the memory allocator 48, by allocating memory based on requests from the host, can control and otherwise manage the data flow between compressed space 46 and persistent memory 50. As will be provided herein with respect to FIG. 4, the memory allocator 48 provides such control and management through the use of filter controllers.

As FIG. 3 indicates, there can be a general flow of data from uncompressed space 42, through transformation space 44 to compressed space 46, and thereafter to persistent storage 50. Similarly, this data flow can operate in reverse, where data from persistent storage 50 can be moved to compressed space 46, uncompressed as it passes through transformation space 44, and thereafter moved to uncompressed space 44 for access by the host computer 49. Transformation space 44 can therefore also provide a staging area for uncompression methods that correspond to the aforementioned compression methods.

Referring now to FIG. 4, there is a block diagram for illustrating one architecture 60 for interfacing between an operating system and a SIMD array according to FIG. 3, and similarly, for illustrating the control of the processing elements and data movement from the uncompressed space 42 to persistent storage 50. In the illustrated embodiment, there is a file store manager 62 that can be part of a file system 64 of a CPU operating system 66 that can be resident on the host device 47. The methods and systems disclosed herein can thus integrate to the host file system 64 at a variety of different levels. In one embodiment, the methods and systems can act as a file or database engine such that the file system can redirect requests for information or data in a specific directory to the file store manager 62. Additionally and optionally, the methods and systems can act as a storage system and the file store manager 62 can be viewed by the native file system 64 as a hard drive or other storage device to which data reads and writes can be made.

The illustrated file store manager 62 can include one or more filter controllers 68. Filter controllers 68 can be understood as to be intermediate drivers or controllers that can intercept and process I/O requests that can be intended for an underlying device such as a directory, database, or other storage device. Those with ordinary skill in the art will also recognize that an intermediate driver or controller such as a filter controller 68 can further be described as an I/O request processor for I/O requests between a highest-level driver, otherwise known in some embodiments as a file system driver, and a lowest-level driver that can control the underlying device for which the I/O request is intended.

In the illustrated embodiment 60, the filter controllers 68 can be context specific and provide management for data processing within the disclosed systems and methods. Accordingly, the filter controllers 68 can understand the context of the requests from the native file system 64, interpret the data being processed, and employ instructions or commands that can organize the data appropriately for application of the SIMD techniques disclosed herein. As indicated herein, context sensitivity of the filter controllers 68 can relate to document type, document contents or format, data type, and request type, although such examples are provided for illustration and not limitation. In one example of context sensitivity, in an embodiment where the methods and systems can be integrated as a file or database engine, writes to text files can be treated differently than those same writes to structured data files. For example, different compression techniques can be utilized and data can be stored differently in the SIMD array to allow more efficient search and query operations. In another example, a write instruction regarding an email can be written to the SIMD array in a manner that can divide the email text into the various fields of the email (e.g., “To:”, “From:”, “CC:”, “BCC:”, “Message:”, etc., with a field representing a column in the SIMD array, for example), while a write instruction regarding a non-email text file may not be organized in the SIMD memory in the same manner. Accordingly, based on the host applications and embodiment, the filter controllers 68 can provide a flexible mechanism to allow data of different types, formats, and/or pertaining to different requests, to be processed by the SIMD array based on application or embodiment-dependent criteria.

Filter controllers 68 can thus also be understood to be application-specific components that operate on data. For example, a filter controller 68 can be designed for encryption, decryption, database access, or another operation that manipulates data. In one embodiment, a filter controller 68 can process by filter blocks 38, where a filter controller 68 can determine an optimal size of a filter block 38 based on the processing to be performed. In the illustrated embodiments, a given filter controller 68 can operate on a filter block 38 that is always the same number of uncompressed stripes 34. For example, for a compression filter controller 68, an uncompressed filter block can be a fixed number of stripes 34, and depending on the compression method and data, the compressed filter block can be a variable number of stripes 34. Upon uncompression, however, the compressed filter block can uncompress into the fixed number of stripes 34 as provided by the compression filter controller 68.

In an embodiment, filter controllers 68 can include one or more processor instructions for causing a processor to operate as provided herein. In the illustrated embodiments, the filter controller instructions can be implemented in a higher level language such as C or C++, although the methods and systems are not limited to such an implementation.

Accordingly, the FIG. 4 file store manager 62 can inspect requests from the host 66 via the file system 64 and determine a filter controller 68 to service the request based on the context of the request. In the illustrated system, a filter controller object 68 can be formed, where the filter controller object 68 can generate one or more data-specific commands for execution by the SIMD array 16a-16d PEs 32a-32N. This list of commands can hereinafter be referred to as a “transaction”. In the illustrated system, the transactions therefore can include instructions to organize data for use by the SIMD array 16a-16d, instructions to process data using the SIMD array 16a-16d, instructions to satisfy file system 64 requests with data from the array 16a-16d, and instructions to store data in persistent memory 50.

In the FIG. 4 system, as provided herein, transactions can be ordered sets of instructions that facilitate the movement of data between the file system 64 and the SIMD array 16a-16d, between the various partitions or memory spaces 42, 44, 46 within the SIMD array 16a-16d, and between the SIMD array 16a-16d and persistent storage 50. The transactions for the illustrated system can also direct entry points for features including compression, uncompression, searching, etc., that can be performed by or within the SIMD array 16a-16d. Other features, including for example, encryption and decryption, can be performed by the SIMD 16a-16d and similarly directed by the transactions.

In one embodiment, if a part of a transaction fails to complete, the entire transaction can fail. In another embodiment, failed portions of transactions can be retried to complete the failed portions.

In one embodiment, filter controllers 68 can build and execute a single transaction for a request from the host 47. Additionally and optionally, a single filter controller 68 can construct an ordered list of transactions that can include transactions from multiple filter controllers 68. The transactions produced by filter controllers 68 can thus provide a library of commands that can be utilized by different filter controllers 68.

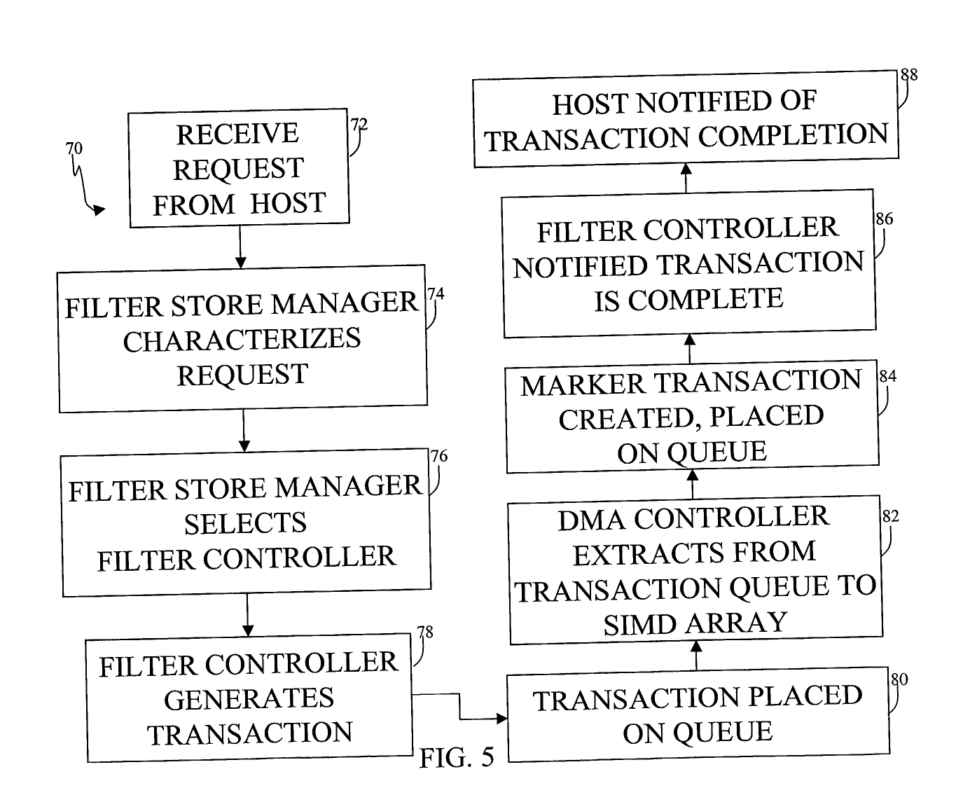

Referring now to FIG. 5, there is a block diagram indicating a sample transaction processing scheme 70 for a system according to FIG. 4. As FIG. 5 indicates, a request can be received 72 from the host processor 66 and characterized 74 by a file store manager 62 based upon the request's data type and the action requested, or as provided herein, the context. The file store manager 62 can thereafter construct or select 76 a filter controller 68 based on the request, where the selected filter controller 68 can select or construct 78 one or more transactions to effectuate the request. The filter controller 68 can add 80 the corresponding transaction(s) to a transaction (“primary”) queue that can be accessed by, for example, a DMA controller. The DMA controller can access 82 the transaction queue and sequentially traverse the transaction queue to process transactions, or portions thereof, in turn. Those with ordinary skill in the art will recognize that the PCI interface between the host 47 and SIMD array PEs 32a-32N can facilitate DMA transfers. Accordingly, for the illustrated systems, the DMA controller can interpret a transaction as a discrete list of commands or instructions for the SIMD array 16a-16d, where a command or instruction can cause the loading of data into the array 16a-16d, unloading of data from the array 16a-16d, or processing of data within the array 16a-16d. The DMA controller can therefore interface the transactions to the SIMD array 16a-16d for execution, and cause data to be retrieved from the SIMD array 16a-16d.

In the system embodiments illustrated herein, the filter controllers 68 can also create a “marker transaction” at the end of a transaction. When a transaction is complete, a “marker transaction” can be generated 84 and placed on the transaction queue. The DMA controller can recognize the marker transaction and generate an interrupt that notifies 86 the selected filter controller 68 that the transaction is complete. The filter controller 68 can thereafter notify 88 the host 47 that the request is complete.

In the illustrated systems, transactions can require that the host 47 perform processing. Such host processing can occur or be required at any time during a transaction. In such instances, for an embodiment according to the illustrated systems, the DMA controller can interrupt the transaction to notify the host 47 that host processing is required. In the illustrated system, this can cause the DMA controller to pause while the host 47 performs the host processing. Accordingly, new requests received by the host 47 therefore may not be moved onto the transaction queue during this time, and thus the illustrated systems can provide a second, deferred transaction queue to accommodate transactions produced by the host 47 during a DMA controller pause. In the illustrated systems, the deferred queue contents can be incorporated into the primary queue for access by the DMA controller.

As indicated previously, the illustrated modular nature of filter controllers 68 and transactions can allow the generation of transactions to provide acceleration of data operations, where the transactions can be compiled in a library. Such transaction libraries can allow for the compilation of a toolkit.

As also mentioned previously, transactions created by the filter controllers 68 can include instructions to organize data between the SIMD array 16a-16d and the host 47. This aspect of filter controllers 68 and transactions allows the SIMD array 16a-16d to exploit its multiple PEs 34 and associated data elements 36 to achieve parallel processing. As illustrated and provided herein, this data organization methodology can allow a perspective of viewing the SIMD array as a row of PEs 34 that have associated therewith, columns of data and/or data elements 36a-36M. In this perspective, data can be loaded into the SIMD array 16a-16d by copying data from the host memory to the PE local memory, and having the PEs simultaneously write the data from the PE local memory into a row of SIMD uncompressed data memory 34. In the illustrated systems, the transfer between the host memory and the PE local memory can be performed via DMA, although other well-known methods and procedures for transferring data can be used. Similarly, data unloading from the SIMD array 16a-16d can be performed by instructing the PEs 32a-32N to simultaneously read one or more rows 34 of the SIMD array 16a-16d into local PE memory, and thereafter having the DMA engine or controller move the data from the PE local memory to the host memory.

In the illustrated systems, the filter controllers 68, through the transactions, can organize data into stripes 34. As mentioned previously, data elements 36a-36M within a stripe 34 can be of varying size depending upon the data being processed, and the appropriate filter controller 68 can determine the size of the data element 36a-36M to use based on the operations to perform. In the illustrated systems, filter controllers 68 can load data to and unload data from the SIMD array 16a-16d as filter blocks 38, although such embodiment is merely for convenience, and other schemes can be practiced. In one embodiment, the requirement to load data by stripe 34 can impose a limitation that data within a stripe may not be accessed by a filter controller 68 unless the access is provided within the host memory.

In the illustrated systems, filter controllers 68 can additionally determine the type of compression to perform, when the compression is performed, and whether additional processing such as encryption, etc., shall be performed. Because filter controllers 68 can operate on filter blocks 38 in the illustrated system, compressed filter blocks also include an integral number of stripes, and uncompress into a filter block of the corresponding type and size.

In the illustrated embodiments, the filter controllers 68 can communicate with the memory allocator 68 of FIG. 3 to request data addresses for the various SIMD partitions 42, 44, 46 or persistent storage 50, and to receive from the memory allocator 68, the addresses. The illustrated memory allocator 68 can be configured to understand that filter controllers 68 can process an integral number of stripes, and hence the memory allocator 68 can provide memory addresses accordingly to a query or request from a respective filter controller 68 for addressing information, to allow the filter controller 68 to properly formulate a transaction with the appropriate addressing information. In the illustrated systems, the memory allocator 48 can utilize a Least Recently Used (LRU) chain, queue, list, etc., to allocate memory in the different memory spaces 42, 44, 46, 50, where the memory spaces (uncompressed 42, transformation 44, compressed 46, and persistent memory 50) can have their own LRU chain, and/or the chains can be implemented differently. For example, uncompressed space 42 can utilize a strict LRU chain, while compressed space 46 can utilize an LRU chain that also considers best fit.

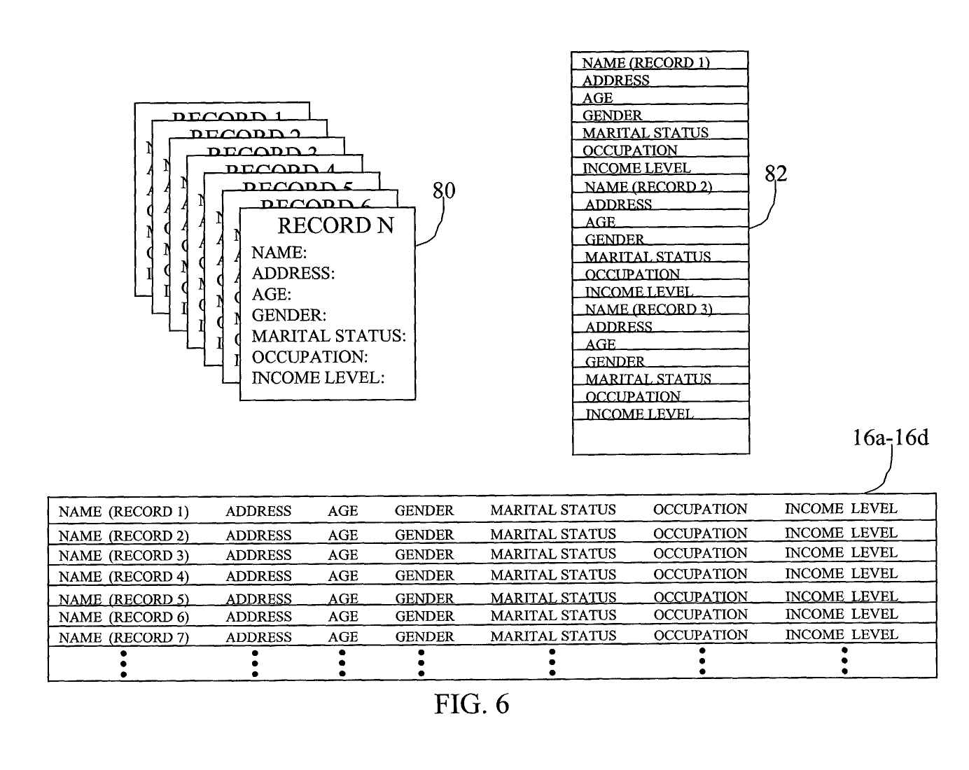

Referring now to FIG. 6, there is an example application for indicating the process by which a filter controller can organize data for insertion into the SIMD array 16a-16d for efficient processing. In this example, the data to be inserted into the SIMD array 16a-16d includes records 80, where a record can include a name, address, age, gender, marital status, occupation, and income level field. Traditional methods of storing these records in memory can be viewed by 82, where one record can follow another sequentially in memory (K records total, where K is a positive integer), either logically or physically, and where data structures such as linked lists, queues, etc., can be implemented to associate the records. The problems of searching these types of data structures are well documented and known.

Alternately, in the illustrated systems and methods, the records 80 can be formatted by a filter controller 68 for processing by a SIMD array 16a-16d. With the SIMD organization based on the disclosed methods and systems, a column can include similar data or information from different records. The columns can be understood to be data element columns 36a-36M associated with PEs 32a-32N of the SIMD array 16a-16d. Searching the records of as organized therein in the FIG. 6 SIMD array 16a-16d can be extremely efficient, as the record fields can be simultaneously searched in a single instruction to the PEs 32a-32N. In an application where a search is to be performed, a filter controller 68 can decide that a command such as a SQL command is most efficient for producing the desired result.

Accordingly, based on, for example, a document type, format, and/or contents, a document can be understood to include multiple modules that can be understood to include document fields, parts, or components as defined by an administrator or user of the methods and systems. A filter controller can understand the modules based on any one or more of the data request, the document type, format, contents, or other context provided herein, and based upon the context, arrange the modules within the SIMD array 16a-16d exploit the parallel processing of the multiple PEs 32a-32N. As shown in FIG. 6, for example, a module (e.g., field of the record) can correspond to a given PE 32a-32N, although other methods of organizing the data can be used, and for example, in another embodiment, a PE 32a-32N can correspond to a single FIG. 6 record such that the columns can include a single record, and a stripe can include the same information from all records. As provided herein, based upon the data organization within the array 16a-16d, the filter controller can create, construct, and/or devise efficient storage, retrieval, and query commands or instructions, among other commands (e.g., compression, encoding, uncompression, decoding, etc.), otherwise known herein as a transaction, to exploit the SIMD array PEs 32a-32N and the data organization within the SIMD array 16a-16d. In some embodiments the commands or instructions can be provided by accessing a library of commands, instructions, or transactions that may have been previously created. Traditional methods of storing data in memory do not provide this type of flexibility or efficiency in data processing.

What has thus been described are methods and systems to interface a SIMD array to a host computer operating system using one or more context sensitive filter controllers. The filter controllers or drivers can intercept I/O requests from the host operating system and redirect the requests to the SIMD array. By using the filter controllers, the SIMD array can be viewed by the host operating system as a file, database engine, and/or other storage device including a hard drive. Based on the request from the host, including the data content, document type, document content, and document or data format associated with the request, the filter controllers can provide a set of instructions to process the request using the SIMD array, while exploiting the parallel processing power of the SIMD array.

The methods and systems described herein are not limited to a particular hardware or software configuration, and can find applicability in many computing or processing environments. The methods and systems can be implemented in hardware or software, or a combination of hardware and software. The methods and systems can be implemented in one or more computer programs executing on one or more programmable computers that include a processor, a storage medium readable by the processor (including volatile and non-volatile memory and/or storage elements), one or more input devices, and one or more output devices.

The computer program(s) is preferably implemented using one or more high level procedural or object-oriented programming languages to communicate with a computer system; however, the program(s) can be implemented in assembly or machine language, if desired. The language can be compiled or interpreted.

The computer program(s) can be preferably stored on a storage medium or device (e.g., CD-ROM, hard disk, or magnetic disk) readable by a general or special purpose programmable computer for configuring and operating the computer when the storage medium or device is read by the computer to perform the procedures described herein. The system can also be considered to be implemented as a computer-readable storage medium, configured with a computer program, where the storage medium so configured causes a computer to operate in a specific and predefined manner.

Many additional changes in the details, materials, and arrangement of parts, herein described and illustrated, can be made by those skilled in the art. Accordingly, it will be understood that the following claims are not to be limited to the embodiments disclosed herein, can include practices otherwise than specifically described, and are to be interpreted as broadly as allowed under the law.

What is claimed is:

1. A method for interfacing an operating system of a host computer and a Single Instruction Stream, Multiple Data Stream (SIMD) array, the method comprising,
receiving a request from the host operating system, and,
providing at least one instruction to process the request using the SIMD array.

2. A method according to claim 1, wherein interfacing includes incorporating into the host file manager.

3. A method according to claim 1, wherein providing at least one instruction includes providing a context sensitive filter controller.

4. A method according to claim 1, wherein providing at least one instruction includes providing a filter controller based on at least one of a data type, the request, a document type, contents of a document, and document format.

5. A method according to claim 1, wherein receiving a request includes receiving a request from at least one of the file system and the file manager.

6. A method according to claim 1, wherein receiving a request includes receiving at least one of an input/output (I/O) request, a read request, and a write request.

7. A method according to claim 1, wherein providing at least one instruction includes providing at least one instruction based on context of the request.

8. A method according to claim 1, wherein providing at least one instruction includes creating a transaction.

9. A method according to claim 1, wherein providing at least one instruction includes retrieving the at least one instruction from previously created instructions.

10. A method according to claim 1, wherein providing at least one instruction includes retrieving the at least one instruction from a library of instructions.

11. A method according to claim 1, wherein providing at least one instruction includes arranging data associated with the request based on the SIMD array.

12. A method according to claim 1, wherein providing at least one instruction includes,
arranging data associated with the request into modules, and,
providing instructions to store the data modules in the SIMD array.

13. A method according to claim 1, wherein providing at least one instruction includes creating a SQL instruction based on the SIMD array.

14. A method according to claim 1, wherein providing at least one instruction includes creating at least one of: at least one search instruction, at least one compression instruction, at least one uncompression instruction, at least one encoding instruction, and at least one decoding instruction.

15. A method according to claim 1, wherein providing at least one instruction includes providing at least one instruction to transfer data between spaces of the SIMD array.

16. A system for interfacing an operating system of a host computer and a SIMD array, the system comprising,
at least one context sensitive filter controller to receive a request from the host operating system, and provide at least one instruction to process the request.

17. A system according to claim 16, wherein the operating system further includes a file manager, and the at least one filter controller communicates with the file manager.

18. A system according to claim 16, wherein the SIMD array includes at least one of a compression space, a transformation space, and an uncompressed space.

19. A system according to claim 16, wherein the at least one filter controller can be based upon at least of a data type, the request, a document type, contents of a document, and document format.

20. A system according to claim 16, wherein the instruction includes at least one of: at least one encoding instruction, at least one decoding instruction, at least one compression instruction, and at least one uncompression instruction.

21. A system according to claim 16, further including a DMA controller to interface the instructions to the SIMD array.

22. A system according to claim 16, further including a memory allocator to allocate memory in the SIMD array based on the at least one instruction.

23. A system according to claim 16, further including at least one transaction queue for storing the at least one instruction.

24. A system according to claim 16, further including a library of the at least one instruction.

25. A system according to claim 16, wherein the SIMD array includes processing elements and local memory.

26. A system according to claim 25, further including,
at least one transaction queue, and,
a DMA controller to transfer instructions from the at least one transaction queue to the local memory of the processing elements.

27. A system according to claim 16, further including a PCI bus to connect the host to the SIMD array.

28. A computer product for interfacing an operating system of a host computer and a SIMD array, the computer product disposed on a computer readable medium, the computer product comprising instructions for causing a processor to:
receive a request from the host operating system, and,
provide at least one instruction to process the request using the SIMD array.

29. A computer product according to claim 28, wherein the instructions to provide at least one instruction include instructions to provide a context-sensitive filter controller.

30. A computer product according to claim 28, wherein the instructions to receive a request include instructions to interface to a file manager of the host operating system.

31. A computer product according to claim 28, wherein instructions provide at least one instruction include instructions to transfer the at least one instruction to the SIMD array.

32. A computer product according to claim 28, wherein instructions to receive a request include instructions to receive at least one of an input/output (I/O) request, a read request, and a write request.

33. A computer product according to claim 28, wherein instructions to provide at least one instruction include instructions to provide at least one instruction based on context.

34. A computer product according to claim 28, wherein instructions to provide at least one instruction include instructions to retrieve the at least one instruction from previously created instructions.

35. A computer product according to claim 28, wherein instructions to provide at least one instruction include instructions to retrieve the at least one instruction from a library of instructions.

36. A computer product according to claim 28, wherein instructions to provide at least one instruction include instructions to arrange data associated with the request based on the SIMD array.

37. A computer product according to claim 28, wherein instructions to provide at least one instruction include instructions to,
arrange data associated with the request into modules, and,
provide instructions to store the data modules in the SIMD array.

38. A computer product according to claim 28, wherein instructions to provide at least one instruction include instructions to create a SQL instruction based on the SIMD array.

39. A computer product according to claim 28, wherein instructions to provide at least one instruction include instructions to create at least one of: at least one search instruction, at least one compression instruction, at least one uncompression instruction, at least one encoding instruction, and at least one decoding instruction.

40. A computer product according to claim 28, wherein instructions to provide at least one instruction include instructions to provide at least one instruction to transfer data between spaces of the SIMD array.

41. A computer product according to claim 28, wherein instructions to provide at least one instruction include instructions to query a memory allocator for address information from the SIMD.

42. A method for interfacing an operating system of a host computer and a Single Instruction Stream, Multiple Data Stream (SIMD) array, the method comprising,
receiving a request from the host operating system, and,
providing at least one context-sensitive filter controller to process the request using the SIMD array.

43. A method according to claim 42, wherein providing at least one context-sensitive filter controller includes providing at least one filter controller based on at least one of a data type, the request, a document type, contents of a document, and document format.

44. A method according to claim 42, wherein receiving a request includes receiving a request from at least one of the file system and the file manager.

45. A method according to claim 42, wherein receiving a request includes receiving at least one of an input/output (I/O) request, a read request, and a write request.

46. A method according to claim 42, wherein providing at least one context-sensitive filter controller includes arranging data associated with the request based on the SIMD array.

47. A method according to claim 42, wherein providing at least one context-sensitive filter controller includes,
arranging data associated with the request into modules, and,
providing instructions to store the data modules in the SIMD array.

48. A method according to claim 42, wherein providing at least one context-sensitive filter controller includes creating a SQL instruction based on the SIMD array.

49. A method according to claim 42, wherein providing at least one context-sensitive filter controller includes creating at least one of: at least one search instruction, at least one compression instruction, at least one uncompression instruction, at least one encoding instruction, and at least one decoding instruction.

50. A method according to claim 42, wherein providing at least one context-sensitive filter controller includes providing at least one instruction to transfer data between spaces of the SIMD array.

51. A method according to claim 42, wherein providing at least one context-sensitive filter includes requesting at least one memory address from a memory allocator, wherein the memory allocator is in communications with the SIMD array, and the at least one requested address is based on the request and the SIMD array.
